(19) United States
(12) Patent Application Publication
(10) Pub. No.: US 2012/0200887 A1
(43) Pub. Date: Aug. 9, 2012

(54) IMAGE FORMING APPARATUS AND CONTROL METHOD THEREOF

(75) Inventor: Mamoru Osada, Kawasaki-shi (JP)

(73) Assignee: CANON KABUSHIKI KAISHA, Tokyo (JP)

(21) Appl. No.: 13/365,094

(22) Filed: Feb. 2, 2012

(30) Foreign Application Priority Data
Feb. 7, 2011 (JP) 2011-023856

(51) Int. Cl. G06K 15/02

(52) U.S. Cl. 358/1.15

(57) ABSTRACT

An image forming apparatus includes a reception unit configured to receive a file including a plurality of applications in a form of a plurality of separated data pieces, a detection unit configured to detect information indicating that an application corresponds to the image forming apparatus from the data received by the reception unit, and a control unit configured to, if the detection unit detects the information indicating that the application corresponds to the image forming apparatus, perform installation processing using data about the application received by the reception unit after the detection, wherein the control unit discards data that is determined as data other than data about the application corresponding to the image forming apparatus from among the data pieces received in the file.

### BACKGROUND OF THE INVENTION

1. Field of the Invention

The present invention relates to a technique for managing an application in an image forming apparatus to which the application can be installed.

2. Description of the Related Art

There is a known technique that mounts, in an image forming apparatus such as a multifunction peripheral and a printer, an application platform for installing and executing a specific application therein to provide a solution to an end user. Further, there is a technique, in which a personal computer (PC) connected with an image forming apparatus acquires a latest control program from a central device using identification information of the image forming apparatus acquired therefrom, and then installs the control program in the image forming apparatus. (For example, refer to Japanese Patent Application Laid-Open No. 2000-309145).

An application operating on the image forming apparatus described above is often configured to discriminate a plurality of models in a program and perform processing according to the model. More specifically, the application includes processing according to the plurality of models in one executable file.

Meanwhile, image forming apparatuses include various types of models from a multifunction peripheral that can deal with an A3 size sheet to a printer that can perform printing only on an A4 size sheet. Additionally, image forming apparatuses vary from one in which a super video graphics array (SVGA) full-screen can be used for an operation unit to one in which only a liquid crystal display (LCD) of several lines in a text base can be used. Sizes of a memory used by the application and for storage, such as a hard disk drive (HDD), vary according to the respective models.

For example, in order to install and execute an application used on a multifunction printer that supports printing on A3 size sheets on a printer that supports printing of A4 size sheets, the memory resource of the A4 supported printer needs to be increased, which can be costly. Further, in the market, there is a great demand for unifying application files as an installation unit from a point of view of operating the application, and thus there is an issue that differentiating the application files according to the models is not appropriate for the demand.

Japanese Patent Application Laid-Open No. 2000-309145 discusses a technique for acquiring information about an image forming apparatus and installing a control program corresponding to the image forming apparatus via a personal computer. However, the technique does not assume to download a file including a plurality of applications corresponding to a plurality of models in the image forming apparatus having a lower storage capacity and to install the file therein. Therefore, in the image forming apparatus having the lower storage capacity, installation processing occasionally failed when not all files including the plurality of applications corresponding to the plurality of models could not be received.

### SUMMARY OF THE INVENTION

According to an aspect of the present invention, an image forming apparatus includes a reception unit configured to receive a file including a plurality of applications in a form of a plurality of separated data pieces, a detection unit configured to detect information indicating that an application corresponds to the image forming apparatus from the data received by the reception unit, and a control unit configured to, if the detection unit detects the information indicating that the application corresponds to the image forming apparatus, perform installation processing using data about the application received by the reception unit after the detection, wherein the control unit discards data that is determined as data other than data about the application corresponding to the image forming apparatus from among the data pieces received in the file.

The present invention provides that, in a case where information about an application for a plurality of models of image forming apparatuses is stored in a file, the information about the application appropriate for the image forming apparatus to be installed can be extracted and the application can be appropriately installed.

Further features and aspects of the present invention will become apparent from the following detailed description of exemplary embodiments with reference to the attached drawings.

### BRIEF DESCRIPTION OF THE DRAWINGS

The accompanying drawings, which are incorporated in and constitute a part of the specification, illustrate exemplary embodiments, features, and aspects of the invention and, together with the description, serve to explain the principles of the invention.

FIG. 1 is an overview of a system according to an exemplary embodiment of the present invention.

FIG. 2 is a block diagram illustrating an apparatus configuration of a single function peripheral (SFP).

FIG. 3 is a software block diagram of the SFP according to the exemplary embodiment of the present invention.

FIG. 4 is a configuration diagram of an application file according to the exemplary embodiment of the present invention.

FIG. 5 is a flowchart illustrating installation processing according to the exemplary embodiment of the present invention.

FIG. 6 is a configuration diagram of an application file according to a second exemplary embodiment of the present invention.

FIG. 7 is a flowchart illustrating a part of installation processing according to the second exemplary embodiment of the present invention.

FIG. 8 illustrates an application file according to a third exemplary embodiment of the present invention.

FIG. 9 is a flowchart illustrating a part of installation processing according to the third exemplary embodiment of the present invention.

### DESCRIPTION OF THE EMBODIMENTS

Various exemplary embodiments, features, and aspects of the invention will be described in detail below with reference to the drawings.

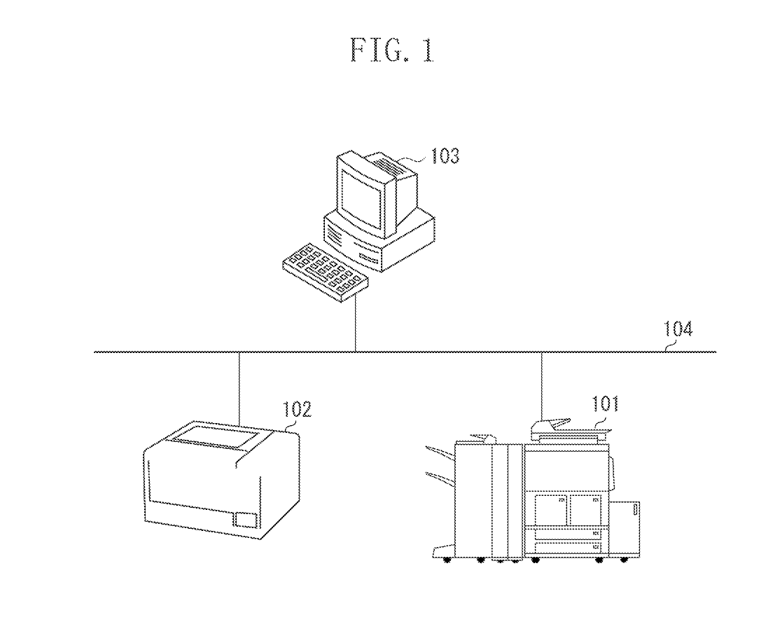

FIG. 1 is an overview of a system according to a first exemplary embodiment. In the system, a single functional peripheral (SFP) 101, and a multi-function peripheral (MFP) 102, which are image forming apparatuses, are communicably connected with each other and to a PC 103 via a local area network (LAN) 104. For description purposes, the following exemplary embodiments are described with reference to the SFP 101. However, the features of the exemplary embodiments are applicable to the MFP 102, as well as any other applicable image forming apparatus.

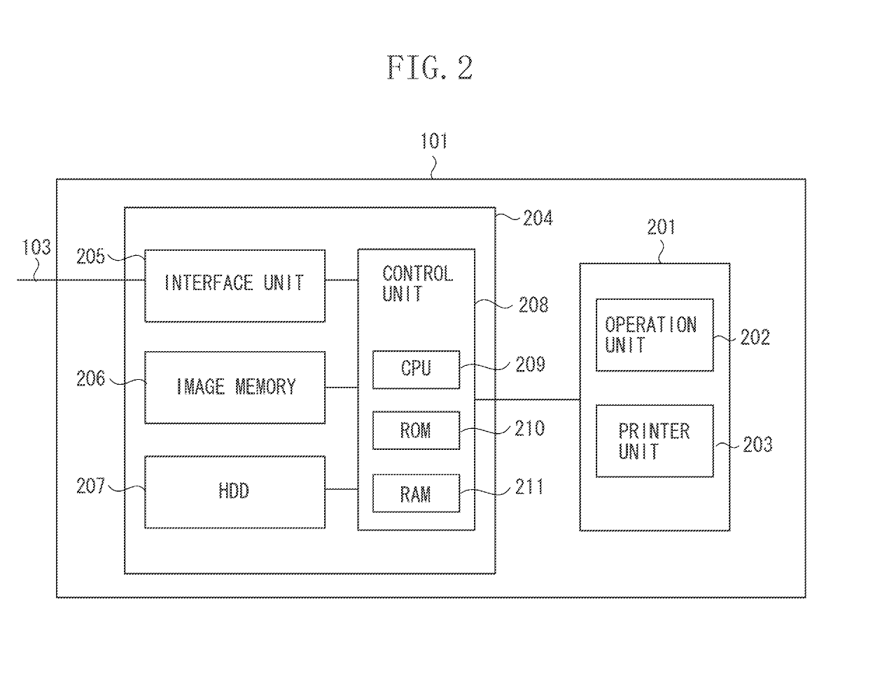

FIG. 2 is a block diagram illustrating an apparatus configuration of the SFP 101. A control unit 208 including a central processing unit (CPU) 209 controls operations of the entire SFP 101. The CPU 209 reads a control program stored in a read only memory (ROM) 210, and executes various control processing such as reading control and transmission control. A random access memory (RAM) 211 is used as a main memory of the CPU 209 and a temporary storage area such as a work area.

An HDD 207 stores image data and various programs. The control unit 208 is connected with a function unit 201, and controls operations of an operation unit 202 and a printer unit 203. The operation unit 202 includes a liquid crystal display unit having a touch panel function and a keyboard. The printer unit 203 performs printing on a recording medium, where the image data to be printed is input from the control unit 208.

An interface unit 205 connects the control unit 208 with the LAN 104, receives image data to be printed from the information processing apparatus on the network (not illustrated in FIG. 2), and receives screen data to be displayed on the operation unit 202. A print image received from the information processing apparatus (not illustrated in FIG. 2) is temporarily stored in an image memory 206, and printed by the printer unit 203 via the control unit 208.

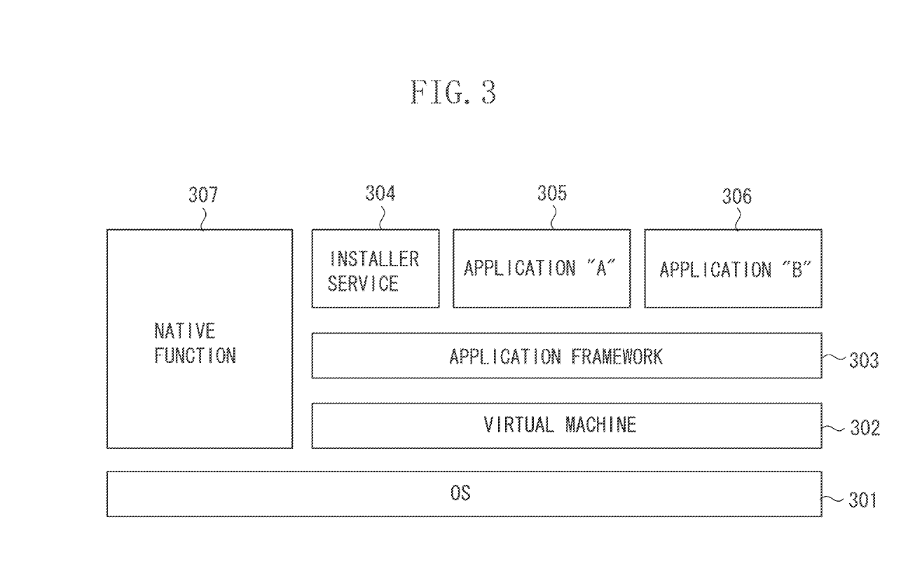

FIG. 3 is a software block diagram of the SFP 101. Each module illustrated in the block diagram in FIG. 3 is stored in the ROM 210 or the HDD 207, and executed by the CPU 209.

An operating system (OS) layer 301 generally uses a real time OS, but any OS that would enable practice of the present embodiment is applicable. A virtual machine 302 provides an execution environment of the application.

An application framework 303 provides a function of managing a life cycle of the application. An installer service 304 performs installation processing by registering a plurality of applications, such as an application “A” and an application “B” described below, in the application framework 303.

Applications 305 and 306 are installed by the installer service 304 and provide various functions on the SFP 101. A user can communicate with the applications 305 and 306 via the operation unit 202 using an interface (I/F) (not illustrated in FIG. 3). Printing can be performed by receiving data from the PC 103 via the interface unit 205 and using a printer unit 204. The installer service 304 is accessed from the PC 103 using a browser, and receives a predetermined application file.

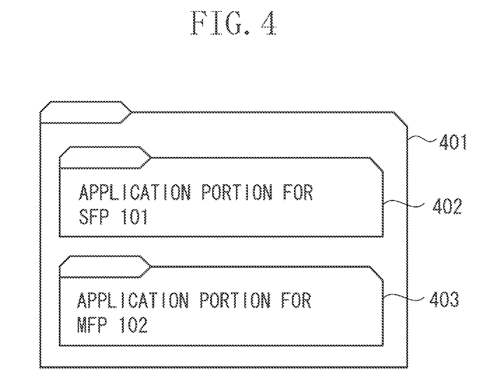

FIG. 4 is a configuration diagram of the application file according to the present exemplary embodiment. An application file 401 indicates an entire portion thereof. An application portion 402 is appropriate for the SFP 101. An application portion 403 is appropriate for the MFP 102. Inside the application portion 401, the application portion 402 for the SFP and the application portion 403 for the MFP are configured to be distinguishable from each other by a markup language such as an extensible markup language (XML).

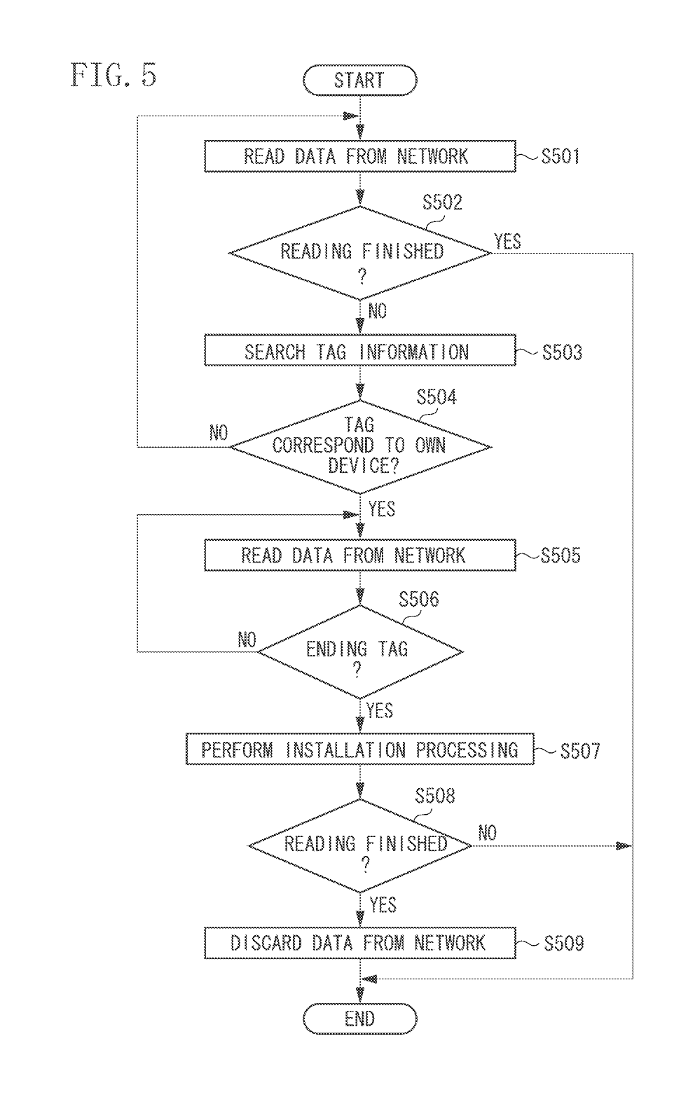

FIG. 5 is a flowchart illustrating the processing when the installer service 304 of the SFP 101 is installed.

In step S501, the installer service 304 reads a predetermined size amount of the application file 401 transmitted from the PC 103 via the I/F unit 205 and the LAN 104, and then temporarily stores the read file.

In step S502, the installer service 304 checks whether reading of all pieces of the data transmitted from the PC 103 has finished. If it is determined that all pieces of the data has been received (YES in step S502), the processing in the flowchart in FIG. 5 is ended.

In step S503, the installer service 304 searches the data having the predetermined size read in step S501 for tag information indicating a start of data for the SFP 101.

In step S504, the installer service 304 checks whether the tag indicating the SFP 101 could be detected in step S503. When the tag has not been detected (NO in step S504), the installer service 304 returns the processing to step S501 to continue to receive the data.

In step S505, the installer service 304 receives the application portion 402 for the SFP 101. In step S505, the installer service 304 receives the application portion 402, and then stores it at a predetermined position in the HDD 207.

In step S506, the installer service 304 detects the tag indicating an end of the data for the SFP 101. When the tag indicating the end of the data is not detected (NO in step S506), the installer service 304 returns the processing to step S505 to repeat receiving the application portion 402.

In step S507, the installer service 304 installs the application portion 402 that has been all received. In step S507, the installer service 304 registers the received application portion 402 with the application framework 303 to perform the installation processing.

In step S508, the installer service 304 determines whether reception of the application file 401 transmitted from the PC 103 has been finished. When the reception is finished (YES in step S508), the installer service 304 ends the processing.

In step S509, the installer service 304 discards the remaining data, which is determined as not related to the application corresponding to the SFP 101, among the data pieces transmitted from the PC 103, thus the application portion 403 for the MFP 102 is abandoned, and the processing is ended.

By the processing described in the flowchart in FIG. 5, the entire application file 401 does not need to be stored in the HDD 207 of the SFP 101, therefore, only the minimum necessary and effective information can be received to perform the installation processing.

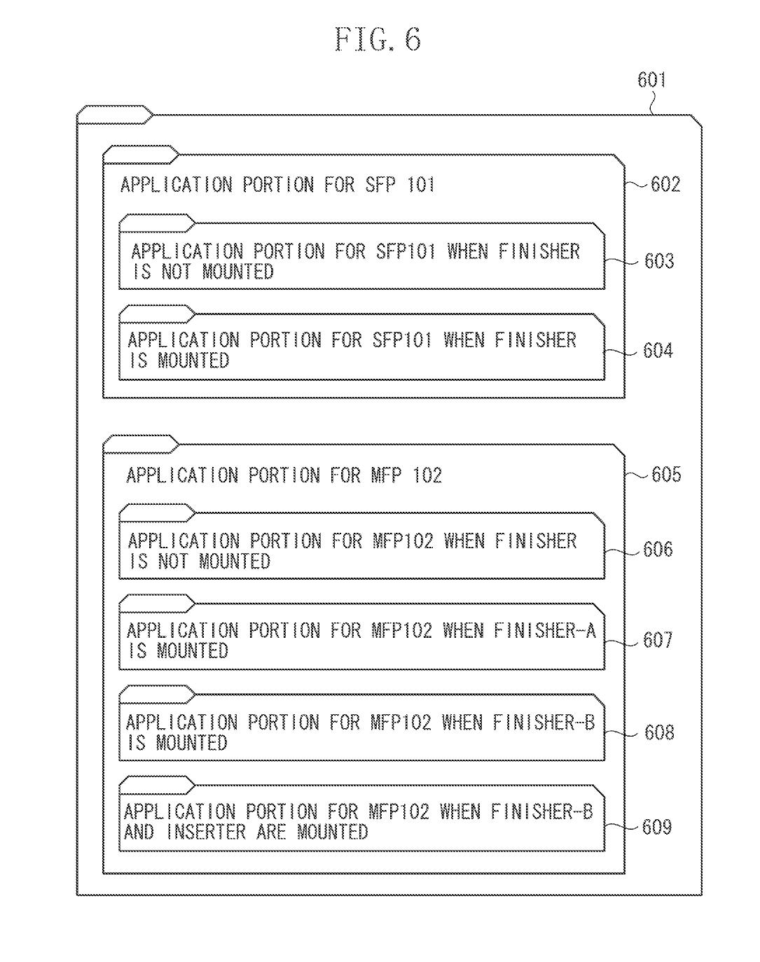

FIG. 6 is a configuration diagram of an application file used in a second exemplary embodiment.

An application file 601 indicates an entire portion thereof. An application portion 602 is appropriate for the SFP 101. An application portion 603 is appropriate for a state in which a finisher is not mounted on the SFP 101. An application portion 604 is appropriate for a state in which the finisher is mounted on the SFP 101.

An application portion 605 is appropriate for the MFP 102. An application portion 606 is appropriate for a state in which the finisher is not mounted on the MFP 102. An application portion 607 is appropriate for a state in which a “finisher-A” is mounted on the MFP 102. An application portion 608 is appropriate for a state in which a “finisher-B” is mounted on the MFP 102. An application portion 609 is appropriate for a state in which the “finisher-B” and an inserter are mounted on the MFP 102.

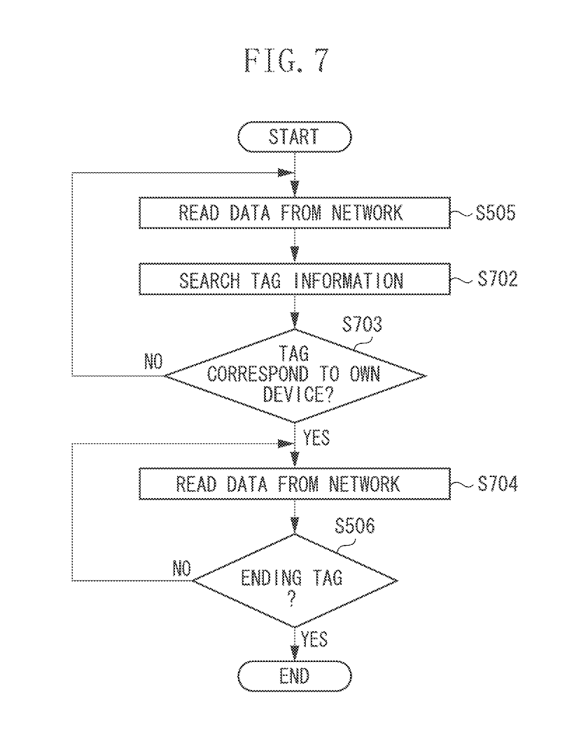

FIG. 7 is a flowchart illustrating processing of the installer service 304 in the SFP 101 according to the second exemplary embodiment. The flowchart in FIG. 7 is acquired by changing the processing between step S505 and step S506 of the flowchart illustrated in FIG. 5. Thus, description of the installation processing other than the flowchart illustrated in FIG. 7 is not repeated. Herein, a case will be described where the finisher is not mounted on the SFP 101.

In step S505, the installer service 304 receives the application portion 602 for the SFP 101. In step S702, the installer service 304 searches the received data for the tag information specifying a state of the SFP 101.

In step S703, the installer service 304 checks whether the tag corresponding to the state of the SFP 101 has been detected in step S702. When the installer service 304 has not detected the tag (NO in step S703), the installer service 304 returns the processing to step S505 to continue to receive the data.

In step S704, the installer service 304 receives the application portion 603 when the finisher is not mounted on the SFP 101. In step S704, the installer service 304 receives the application portion 603 and stores it in a predetermined position of the HDD 207.

In step S506, the installer service 304 detects the tag indicating the end of the data of the application portion 603 when the finisher is not mounted on SFP 101. When the tag indicating the end of the data is not detected (NO in step S703), the installer service 304 returns the processing to step S704 to repeat receiving the application portion 603.

In a third exemplary embodiment, a case will be described where an application file 401 or an application file 601 transmitted from the PC 103 described in the first and second exemplary embodiments is encrypted. In such a case, in order to confirm validity of the application file, the entire application file needs to be received. Further, the third exemplary embodiment can be applied to a case where the configuration information about the application used for installation is separated for each application to be extracted.

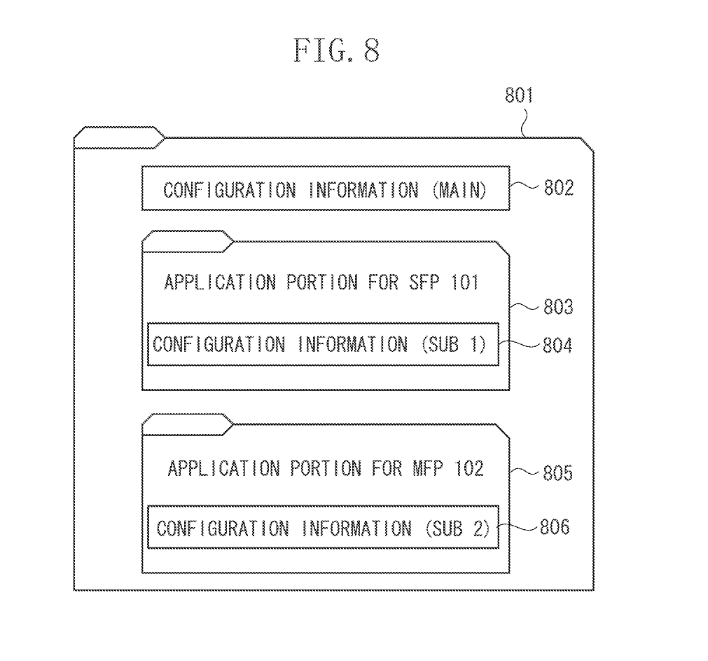

FIG. 8 illustrates the application files used in the third exemplary embodiment. An application file 801 indicates an entire portion thereof which is transmitted from the PC 103. Configuration information (main) 802 is defined as an entire portion of the application, and, for example, stores an application name.

An application portion 803 is appropriate for the SFP 101. Configuration information (sub 1) 804 includes information specific to the SFP 101 as the application 801 and complements the configuration information (main) 802 when the application appropriate for the SFP 101 is extracted.

An application portion 805 is appropriate for the MFP 102. Configuration information (sub 2) 806 stores information specific to the MFP 102 as the application 801 and complements the configuration information (main) 802 when the application appropriate for the MFP 102 is extracted.

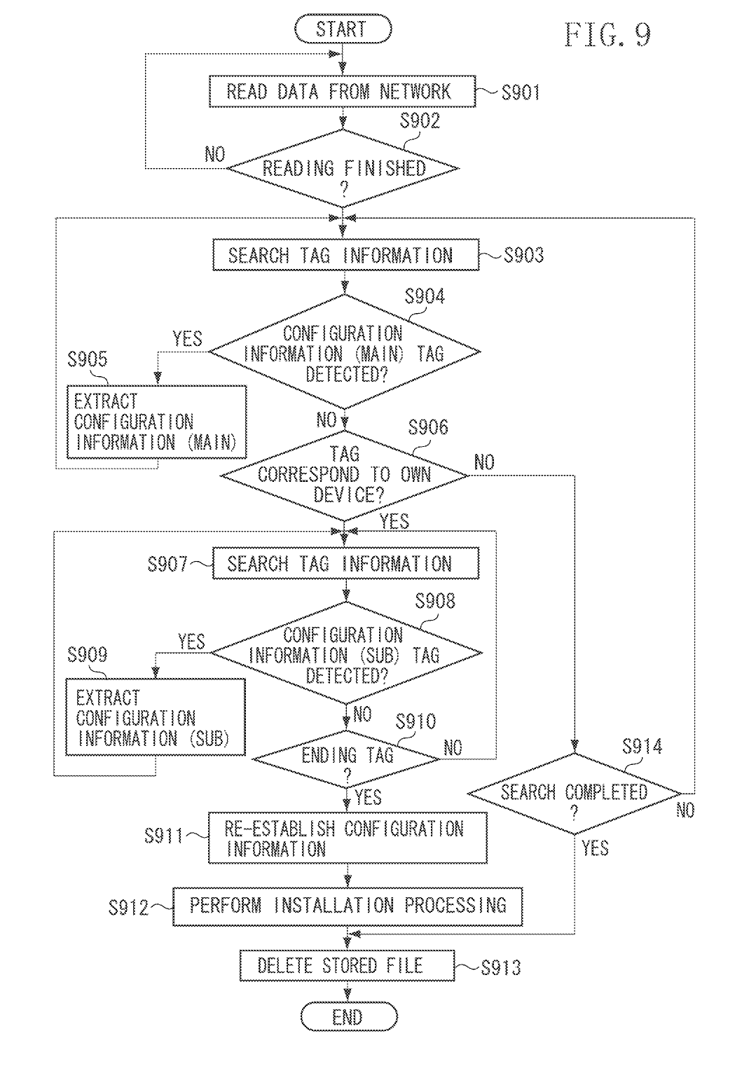

FIG. 9 is a flowchart illustrating processing of the installer service 304 of the SFP 101 according to the third exemplary embodiment.

In step S901, the installer service 304 reads a predetermined size amount of the application file 801 transmitted from the PC 103 via the I/F unit 205 and the LAN 104, and stores the read portion in a predetermined position of the HDD 207.

In step S902, the installer service 304 checks whether reception of the entire application file 801 has been finished. When installer service 304 has not finished the reception yet (NO in step S902), the processing returns to step S901.

In step S903, the installer service 304 searches the application file 801 stored in the HDD 207 for the configuration information (main) 802 and the application portion 803 for the SFP 101 with use of the tag information.

In step S904, the installer service 304 determines whether the configuration information (main) 802 has been detected. If the installer service 304 has detected the configuration information (YES in step S904), the processing proceeds to step S905, whereas if not (NO in step S904), the processing proceeds to step S906.

In step S905, the installer service 304 extracts the configuration information (main) 802 from the application file 801 stored in the HDD 207. The extracted data is stored in a predetermined position of the HDD 207.

In step S906, the installer service 304 determines whether the application portion 803 for the SFP 101 has been detected. If the installer service 304 has detected the application portion 803 (YES in step S906), the processing proceeds to step S907, whereas if not (NO in step S906), the processing proceeds to step S914.

In step S914, the installer service 304 determines whether the search for the tag in step S903 has been completed. If it is determined that the search has been completed (YES in step S914), the processing proceeds to step S913, whereas if not (NO in step S914), the processing returns to step S903, and the installer service 304 repeats the search for the tag information.

In step S907, the installer service 304 searches the application portion 803 for the SFP 101 for the tag indicating the configuration information (sub) or an end edge of the application portion 803 for the SFP 101.

In step S908, the installer service 304 determines whether the configuration information (sub 1) 804 has been detected, for example as the configuration information (sub). If the configuration information (sub 1) 804 has been detected (YES in step S908), the processing proceeds to step S909, whereas if not (NO in step S908), the processing proceeds to step S910.

In step S909, the installer service 304 extracts the configuration information (sub 1) 804 from the application portion 803 for the SFP 101. The extracted data is stored in a predetermined position of the HDD 207.

In step S910, the installer service 304 determines whether the end edge of the application portion 803 for the SFP 101 has been detected. If the installer service 304 has detected the end edge (YES in step S910), the processing proceeds to step S911. If the installer service 304 has not detected the end edge (NO in step S910), the installer service 304 returns the processing to step S907 to repeat the processing described above.

In step S911, the installer service 304 re-establishes the configuration information appropriate for the application portion for the SFP 101 from the configuration information pieces extracted in steps S905 and S909.

In step S912, the installer service 304 extracts a execution program portion of the application portion 803 for the SFP 101 extracted in steps S906 to S910, and performs the processing for installing the program together with the configuration information re-established in step S911.

In step S913, the application file 801 stored in the predetermined position of the HDD 207 in steps S901 and S902, and the configuration information pieces 802 and 804 stored in the predetermined position of the HDD 207 in steps S905 and S909 are deleted. Then the processing in flowchart in FIG. 9 is ended.

When the application file is not encrypted, like in the first and second exemplary embodiments, the processing can be switched to read a part of the data in the application file and discard an unnecessary portion.

According to the present exemplary embodiment, if the application file is received but the appropriate portion cannot be extracted from the application file due to encryption, only the appropriate portion can be extracted to install the application in an optimum size.

While the present invention has been described with reference to exemplary embodiments, it is to be understood that the invention is not limited to the disclosed exemplary embodiments. The scope of the following claims is to be accorded the broadest interpretation so as to encompass all modifications, equivalent structures, and functions.

This application claims priority from Japanese Patent Application No. 2011-023856 filed Feb. 7, 2011, which is hereby incorporated by reference herein in its entirety.

What is claimed is:

1. An image forming apparatus comprising at least a processor, functioning as:
a reception unit configured to receive a file including a plurality of applications in a form of a plurality of separated data pieces via a network;
a detection unit configured to detect information indicating that an application corresponds to the image forming apparatus from the data received by the reception unit; and
a control unit configured to, if the detection unit detects the information indicating that the application corresponds to the image forming apparatus, perform installation processing using data about the application received by the reception unit after the detection,
wherein the control unit discards data that is determined as data other than data about the application corresponding to the image forming apparatus from among the data pieces received based on the file.

2. The image forming apparatus according to claim 1,
wherein, if the detection unit detects the information indicating that the application corresponds to the image forming apparatus, from the data about the application which is received by the reception unit after the detection, the detection unit detects information indicating that the application corresponds to a state of the image forming apparatus,
wherein, if the detection unit detects the information indicating that the application corresponds to the state of the image forming apparatus, the control unit performs installation processing using data about the application corresponding to the state of the image forming apparatus which is received by the reception unit after the detection, and
wherein, the control unit further discards data that is determined as data other than data about the application corresponding to the state of the image forming apparatus from among the data pieces received based on the file.

3. The image forming apparatus according to claim 2, wherein the state of the image forming apparatus refers to a state in which either of a finisher or an inserter is mounted to the image forming apparatus.

4. A method for controlling an image forming apparatus, the method comprising:
receiving a file including a plurality of applications in a form of a plurality of separated data pieces via a network;
detecting information indicating that an application corresponds to the image forming apparatus from the received data;
controlling, if the information indicating that the application corresponds to the image forming apparatus is detected, to perform installation processing using data about the application received after the detection; and
discarding data that is determined as data other than data about the application corresponding to the image forming apparatus from among the data pieces received based on the file.

5. The method according to claim 4, further comprising
detecting, if the information indicating that the application corresponds to the image forming apparatus is detected, information indicating that the application corresponds to a state of the image forming apparatus from the data about the application which is received after the detection,
performing, if the information indicating that the application corresponds to the state of the image forming apparatus is detected, installation processing using data about the application corresponding to the state of the image forming apparatus which is received after the detection, and
discarding data that is determined as data other than data about the application corresponding to the state of the image forming apparatus from among the data pieces received based on the file.

6. The method according to claim 5, wherein the state of the image forming apparatus refers to a state in which either of a finisher or an inserter is mounted to the image forming apparatus.

7. A computer readable storage medium which stores a computer program for causing a computer to execute a method for an image forming apparatus, the method comprising:
receiving a file including a plurality of applications in a form of a plurality of separated data pieces via a network;
detecting information indicating that an application corresponds to the image forming apparatus from the received data;
controlling, if the information indicating that the application corresponds to the image forming apparatus is detected, to perform installation processing using data about the application received after the detection; and
discarding data that is determined as data other than data about the application corresponding to the image forming apparatus from among the data pieces received based on the file.
